(19) United States
(12) Patent Application Publication
(10) Pub. No.: US 2025/0241507 A1
(43) Pub. Date: Jul. 31, 2025

(54) LOADING SYSTEM FOR LOADING A TRANSPORT DISHWASHER WITH WASH WARE ITEMS AND ARRANGEMENT FOR AT LEAST PARTIALLY AUTOMATED CLEANING OF WASH WARE ITEMS WITH A LOADING SYSTEM

(71) Applicant: ILLINOIS TOOL WORKS INC., Glenview, IL (US)

(72) Inventors: Harald DISCH, Elzach (DE); Martin SCHREMPP, Biberach (DE); Adrian BOLDT, Offenburg (DE); Jürgen SCHEMEL, Achern (DE); Norbert LITTERST, Offenburg (DE)

(21) Appl. No.: 19/036,182

(22) Filed: Jan. 24, 2025

(30) Foreign Application Priority Data
Jan. 30, 2024 (DE) 10 2024 102 560.3

(51) Int. Cl. A47L 15/24

(52) U.S. Cl. CPC A47L 15/248; A47L 15/241

(57) ABSTRACT

A loading system for loading a conveyor warewasher, wherein a piece of washware placed in a first region of a conveyor belt can be moved to or in the direction of a second region of the conveyor belt. The conveyor belt includes a clock-in lane subdivided into an upper first section and a lower second section and, in a region between the sections, a turning apparatus is arranged and configured to turn a piece of washware picked up from the clock-in lane and moved in the region between the first and second sections by 180° and subsequently transfer the piece of washware to the second section of the clock-in lane. Below the region between the first and second sections of the clock-in lane, a dirt collection region is provided, in which dirt can be received, having fallen from the piece of washware by way of gravity.

### TECHNICAL FIELD

The invention relates to a loading system for loading a conveyor warewasher with washware pieces. In particular, the invention relates to a loading system for automated or at least semi-automated loading of different conveying lanes of at least one conveyor warewasher.

The invention further relates to a corresponding conveyor warewasher.

### BACKGROUND

Conveyor warewashers of the conveyor warewasher assembly according to the invention are, in particular, commercial conveyor warewashers and can be configured as belt conveyor warewashers or as rack conveyor warewashers.

Conveyor warewashers are used in the commercial sector. Unlike domestic dishwashers, in which the dishes to be cleaned remain stationary in the machine during cleaning, in conveyor warewashers the washware is conveyed through different treatment zones of the machine.

In conveyor warewashers, the washware, such as trays, dishes, pots, glasses, cutlery, and other utensils to be cleaned, are conveyed through a number of treatment zones, such as prewash zone(s), main wash zone(s), postwash or prerinse zone(s), final rinse zone(s), and drying zone(s). A conveyor apparatus is used to transport washware in a conveying direction through the conveyor warewasher, which usually comprises at least one conveyor lane with compartments for receiving washware. In a belt conveyor dishwasher, the compartments can be formed by support fingers on a conveyor lane of the conveyor apparatus, which defines the conveyor belt. In rack conveyor warewashers, dish racks, in which compartments can be configured to receive the washware to be treated, serve as the conveyor apparatus. It is contemplated for the dish racks to be transported through the rack conveyor dishwasher by means of a conveying device of a conveying lane.

The washware to be cleaned is typically presorted before being placed into the conveyor belt. A rack conveyor warewasher is known from publication U.S. Pat. No. 6,530,996 B2, for example, in which the washware to be treated is delivered to the respective treatment zones after being presorted in dish racks.

Conveyor warewashers are used in particular in large facilities such as dining halls and cafeterias in order to clean large quantities of soiled washware as economically as possible. With the conveyor warewashers of the currently known type, it is possible to clean several hundred place settings per hour. Studies have shown that, on average, each place setting typically consists of a tray, a plate, one or two bowls, a drinking glass, and a set of cutlery.

In almost all large kitchens, such as company cafeterias or dining halls, the washware used by the meal participants (dishes, drinking glasses, cutlery, etc.) is returned on trays. From the return station, the place settings are conveyed to the washing region. The place settings are typically conveyed by a corresponding feed conveyor belt. The place setting is conveyed by a conveyor belt from the return station into the washing region directly to a loading region of the conveyor warewasher. In the loading/intake region of the conveyor warewasher, the washware pieces are then usually removed manually by service personnel and sorted into the conveyor belt of the conveyor warewasher.

With respect to trays or tray-like articles, presorting is usually carried out in such a way that the set of dishes and cutlery is removed manually from a tray to be cleaned by the service personnel, and the tray is then stacked in front of the conveyor apparatus or in the intake region (soiled side) of the conveyor warewasher. From time to time, the trays from this stack of trays are placed only with other trays into the conveyor belt of the conveyor warewasher and cleaned.

This homogenous approach has the advantage that trays cannot cast a spray shadow on smaller washware pieces stacked behind the trays. This approach also makes the work flow of stacking and unstacking much easier and more efficient than mixing the washware in with the trays to be cleaned.

However, while the trays from this stack of trays are placed only with other trays into the conveyor belt of the conveyor warewasher and cleaned, it is not possible to clean other washware, such as plates, bowls, or other dishes, because the trays to be placed into the conveyor belt must usually be placed into the conveyor belt transverse to the conveying direction and thus fill the entire available surface of the conveyor belt. Therefore, compared to other types of washware, a relatively large amount of time must be spent cleaning trays.

Furthermore, the service personnel of the conveyor warewasher must include each tray in their work flow at the machine inlet twice: the first time when removing the cutlery and dishes from the tray to be cleaned, and the second time when actually placing the trays into the conveyor belt of the conveyor warewasher.

In the described work process, the manual effort is particularly high. Each piece of washware (dish) of each place setting must be individually removed manually from the tray and placed into the conveyor belt of the warewasher.

Furthermore, the individual pieces of cutlery of each place setting must be removed manually from the tray and likewise delivered to the conveyor warewasher. This is followed by the previously described treatment of the actual trays.

With a machine capacity of several thousand plates per hour, it is in particular important to work as quickly and efficiently as possible, which increases the physical strain on the service personnel.

### SUMMARY

Based on this problem, the underlying object of the present invention is to provide a solution for conveyor dishwashers of the type mentioned at the beginning, in which it is possible to configure the entire washing and rinsing process more efficiently, as a result of which in particular the working time of the washing personnel can be decreased and the consumption of resources of the warewasher assembly can be reduced.

Accordingly, the invention relates in particular to a loading system for loading a conveyor warewasher with washware pieces. The loading system comprises a conveyor belt, which is configured in particular as a slide, in order to feed washware pieces that have been fed, for example, via a feed conveyor belt via the conveyor belt of the conveyor warewasher, and in particular via a conveyor lane of the conveyor warewasher.

For this purpose, the conveyor belt is in particular configured as a slide, although other designs are also possible for the conveyor belt. The conveyor belt is preferably inclined in particular in relation to the horizontals in such a way that a piece of washware placed, for example manually, in an in particular upper first region of the conveyor belt is movable, preferably exclusively by gravity, to or in the direction of an in particular lower second region of the conveyor belt lying opposite the first region.

The washware piece can be placed manually in the first region of the conveyor belt, although an automated solution with the help of a robot is also contemplated here.

With regard to the conveyor belt of the loading system according to the invention, it is provided that it comprises at least one clock-in lane extending in the longitudinal extension direction of the conveyor belt, wherein the at least one clock-in lane is subdivided into an in particular upper first section and an in particular lower second section. The first section of the clock-in lane is in particular part of the first region of the conveyor belt, while the second section of the clock-in lane is in particular part of the second region of the conveyor belt.

In a region between the first and second sections of the clock-in lane, a turning apparatus connecting the first section of the clock-in lane to the second section of the clock-in lane is arranged, which is configured so as to turn a piece of washware picked up from the clock-in lane and moved in the region between the first and second sections of the clock-in lane by 180° and subsequently transfer the piece of washware which has been turned by 180° to the second section of the clock-in lane, so that the washware piece rotated by 180° can then be moved further to the second region of the conveyor belt.

According to the present invention, it is provided in particular that below the region between the first and second sections of the clock-in lane, i.e., in the region in which the turning apparatus is also arranged, a dirt collection region is provided, in which dirt can be received, having fallen from the piece of washware by way of gravity upon turning of the piece of washware.

With this solution, a number of advantages can be achieved.

In particular, the loading system according to the invention is a loading system with which manual handling steps for loading the conveying apparatus of a conveyor warewasher machine are further reduced, because the washware pieces, such as plates and bowls, can be at least semi-automatically sorted into the main conveyor belt of the conveyor warewasher. In this way, the manual working steps are reduced and thus the effort required for the operator is reduced, because the movement sequence for loading the washware pieces, in particular plates and bowls, is in particular optimized for the operator due to the fact that no 180° rotation is necessary, for example, of the bowls between the removal of the bowls from, for example, a tray and the loading of the bowls into the conveyor belt of the loading system. The rotation of the bowls occurs within the loading system, namely by way of the turning apparatus.

In addition, no sorting of the washware pieces into dedicated conveyor belt compartments, in particular the main conveyor belt of the conveyor warewasher, is necessary, because the loading system according to the invention is used in order to clock the washware pieces into the conveyor belt by way of the loading system itself.

In particular, the cleaning result of the conveyor warewasher can thus be improved, because in an easily implemented yet still effective and in particular at least semi-automated manner, it is ensured that all washware is uniformly oriented on the conveyer belt of the conveyor warewasher and preferably travels sorted according to type within the dedicated lanes of the main conveyer belt of the conveyor warewasher.

In the further course, this also simplifies the unloading process of the conveyor warewasher or conveyer belt of the conveyor warewasher, because each type of washware is transported on a defined conveyor lane through the warewasher and thus arrives at the unloading region of the conveyor warewasher in a pre-sorted manner.

In particular, the loading system differs significantly from a loading system in which a turning wheel is used in order to transfer the washware pieces to be cleaned and to clock them into the main conveyor belt of the warewasher, as is known for example from publication KR100977943B1 or from publication KR101487193B1. Turning wheels known for example from this prior art have a certain front toothing or corresponding support fingers, wherein a peripheral region of the washware to be treated is retracted between two support fingers or in a front toothing of the turning wheel and then rotated over a certain angular degree by a rotation of the turning wheel.

The disadvantage of such turning wheels generally known from technical cleaning can be seen in particular in that, if the (dirty) washware piece is rotated with the aid of such a turning wheel, food residues or other dirt still present in the washware piece can fall down by way of gravity and soil the mechanism or the turning wheel, or even the second section of the clock-in lane.

In particular, in the case of a turning apparatus designed as a turning wheel, the dirt, i.e., waste picked up on or in the washware piece, does not fall into the region between the first and second section of the clock-in lane due to its gravitational force, but actually falls into the region of the second section of the clock-in lane. This in turn means that a section of the clock-in lane, i.e., where the washware piece is to be placed, is loaded with dirt, which leads to the risk that this dirt is also fed into the main conveyor belt of the conveyor warewasher along the clock-in lane.

Apart from this, turning wheels generally require a relatively large design space.

These problems are solved by the invention, in particular due to the fact that the turning apparatus comprises a turning compartment, in particular in the form of a drawer which is open on one side and at least substantially box-shaped.

Due to the fact that the turning apparatus is configured as a turning compartment, it is ensured that, when the washware piece is rotated by 180°, the dirt, i.e., the waste picked up on the item being washed, falls within the region between the first and second sections of the clock-in lane (and in particular not within the region of the second section of the clock-in lane) due to its gravitational force, such that a separation from the second section of the clock-in lane is carried out and it is thus ensured that the dirt falling down from the washware piece upon rotation of the washware piece is fed to the main conveyer belt of the conveyor warewasher via the second section of the clock-in lane.

In particular, it is thus provided according to the present invention that, below the region between the first and second sections of the clock-in lane of the loading system according to the invention, a dirt collection region is provided, in which dirt can be received, having fallen from the piece of washware by way of gravity upon turning of the piece of washware.

According to a preferred implementation of the loading system according to the invention, it is thus provided that the turning apparatus comprises a turning compartment, in particular in the form of a drawer which is open on one side and at least substantially box-shaped. The turning compartment can be transferred between a first position in which the piece of washware picked up from the clock-in lane and moved in the region between the first and second sections of the clock-in lane is received at least partially or regionally by the turning compartment and a second position in which the turning compartment with the piece of washware received at least partially or regionally by the turning compartment has been turned by 180° in relation to the first position of the turning compartment.

Of course, in this context, it is not absolutely necessary for the turning compartment to have closed wall faces. Corresponding grids or rod structures are also contemplated.

According to further developments of the invention, it is provided that the turning compartment, which is configured in particular in the form of a drawer which is open on one side and at least substantially box-shaped, is pivotally supported about an at least substantially horizontally extending axis between the first and second positions in relation to the first and second sections of the clock-in lane.

According to embodiments of the loading system according to the invention, it is provided that the turning compartment, which is configured in particular in the form of a drawer which is open on one side and at least substantially box-shaped, comprises a floor region in the first position of the turning compartment and a front wall region in the first position of the turning compartment facing the second section of the clock-in lane, wherein the piece of washware preferably abuts the front wall region of the turning compartment when, in the first position of the turning compartment, the piece of washware is or has been received at least partially or regionally.

It is not absolutely necessary that the wall region of the turning compartment facing the second section of the clock-in lane is a continuously closed wall region. It is also contemplated, for example, that the wall region is only formed by a strut, bar, or line.

In particular, the turning compartment is pivotally mounted about the at least substantially horizontally extending axis in such a way that the front wall region of the turning compartment faces the first section of the clock-in lane in the second position of the turning compartment.

In the first position of the turning compartment, the surface of the floor region of the turning compartment, the surface of the first section of the clock-in lane, and the surface of the second section of the clock-in lane lie preferably in a common plane so that the washware piece to be turned can easily slide from the first section of the clock-in lane into the turning compartment.

According to implementations of the loading system according to the invention, it is provided that the turning compartment, which is configured in particular in the form of a drawer which is open on one side and at least substantially box-shaped, comprises at least one support, which is configured so as to prevent the piece of washware that has been received at least partially or regionally by the turning compartment from falling out of the turning compartment upon transfer of the turning compartment from the first position to the second position.

In this way, very sensitive washware pieces, such as fine ceramic china, can also be processed with the loading system without the risk of damaging the piece, in particular in the turning apparatus.

This also provides a significant advantage compared to a turning apparatus designed as a turning wheel, in which, when a certain turning angle is reached, the piece of washware previously received by the turning wheel falls out of the turning wheel, which can lead to damage to that piece of washware.

Various embodiments are considered for the implementation of the aforementioned support. For example, it is contemplated that the at least one support comprises a supporting body, which can be inserted as needed, in particular laterally, into the turning compartment.

On the other hand, it is also contemplated that the support is equipped with a guide, which is configured so as to prevent the piece of washware that has been received at least partially or regionally by the turning compartment from falling out of the turning compartment upon transfer of the turning compartment from the first position to the second position.

It is contemplated in this context in particular that the turning compartment, which is configured in particular in the form of a drawer which is open on one side and at least substantially box-shaped, comprises at least one guide configured in particular as an undercut extending in the longitudinal extension direction of the conveyor belt and running parallel to the floor region of the turning compartment, in particular in the form of a guide bar or guide rail, wherein, in the second position of the turning compartment, the surface of the guide, the surface of the first section of the clock-in lane, and the surface of the second section of the clock-in lane lie in a common plane.

This has the significant advantage that, after the turning compartment has been rotated by 180° with the washware piece received therein, the washware piece thus rotated can be transitioned from the likewise rotated turning compartment into the second section of the clock-in lane without any obstacles.

According to implementations of the loading system according to the invention, it is provided in particular that the turning apparatus of the loading system comprises an actuator which operates in particular electrically, electromagnetically, pneumatically, or hydraulically and is configured so as to transfer the turning compartment as needed from the first position to the second position (and vice versa).

In this context in particular, it is expedient that the turning apparatus comprises a sensor, in particular in the form of a presence detector or presence switch, which is configured so as to detect a state when a piece of washware is at least partially or regionally picked up by the turning compartment. The sensor technology can also comprise non-contacting, optical sensors, for example a light barrier or a light curtain. The actuator of the turning apparatus is associated with a control device or the actuator of the turning apparatus comprises a corresponding control device, which is configured so as to drive the actuator in such a manner that the actuator transfers the turning compartment from the first position into the second position when it is detected by means of the sensor that a piece of washware has been received at least partially or regionally by the turning compartment.

In this context, it is also expedient that the turning compartment is pivotally mounted about an axis extending at least substantially horizontally and preferably perpendicular to the longitudinal extension direction of the conveyor belt in such a way that the turning compartment moves independently or automatically from the first position towards the second position when, in the first position of the turning compartment, a piece of washware is or has been received at least partially or regionally by the turning compartment.

In this context, the sensor system can be configured so as to detect the fact that the turning compartment is moving from the first position towards the second position, in particular when, in the first position of the turning compartment, a piece of washware is or has been received at least partially or regionally by the turning compartment.

The dirt falling from the piece of washware by way of gravity upon turning of the piece of washware can in particular be supplied to the dirt collection region via an opening defined by an edge region of the dirt collection region. The edge region of the dirt collection region, which defines the opening of the dirt collection region, is arranged in a plane that runs parallel from and preferably parallel to the plane in which the surface of the floor region of the turning compartment lies in the first position of the turning compartment.

With this design variant, a design as encapsulated as possible of the dirt collection region is possible so that it is effectively prevented that dirt falling down from the washware piece during rotation of the washware pieces reaches the region of the second section of the clock-in lane. The transfer of the dirt falling down from the washware piece during the turning operation via the second section of the clock-in lane onto the conveying apparatus of the conveyor warewasher is thus particularly effectively prevented.

The turning apparatus can preferably be activated as needed, wherein, in a non-activated state of the turning apparatus, the piece of washware that has been picked up by the clock-in lane and moved into the region between the first and second sections of the clock-in lane is transferred to the second section of the clock-in lane without a 180° turning of the piece of washware.

In order to enable this, it is contemplated that the front wall region of the turning compartment, which is open on one side and configured as an at least substantially box-shaped drawer, can be optionally retracted into or extracted from the movement path of the washware piece specified by the clock-in lane.

As stated above, the conveyor belt can be configured as a conveyor slide, so that the washware piece placed in the first region of the clock-in lane is preferably feedable to the second section of the clock-in lane purely by gravity. Alternatively, it is contemplated that the conveyor belt is configured at least partially or regionally as a roller belt having a plurality of rollers extending perpendicular to the longitudinal extension direction of the conveyor belt and being in particular rotatably supported.

Alternatively or additionally, the conveyor belt can comprise a conveyor device with which the washware piece placed in the first region of the conveyor belt or the washware piece placed in the first section of the clock-in lane of the conveyor belt can be moved towards the second region of the conveyor belt or towards the second section of the clock-in lane.

Preferably, the conveyor belt of the loading system is subdivided into a plurality of clock-in lanes running parallel to one another, wherein not every clock-in lane must be equipped with a turning apparatus. In particular, only the clock-in lanes are provided with a corresponding turning apparatus for which the associated washware types require a rotation of 180° when loaded into the main conveyor belt of the conveyor warewasher.

The at least one clock-in lane of the conveyor belt, and in particular each clock-in lane of the conveyor belt, is associated with a specific size and/or dimension or type of washware.

Preferably, at least one cover is associated with the at least one clock-in lane, being configured so as to cover the associated clock-in lane at least partially or regionally from above, so that the clock-in lane forms with the cover a shaft-like channel for receiving corresponding pieces of washware, wherein the cover is preferably configured so as to be removable from the associated clock-in lane.

In order to ensure a particularly trouble-free operation of the loading system, the loading system comprises a device for clocking the movement of the washware pieces received in one clock-in lane from the first region of the conveyor belt to the second region of the conveyor belt or from the first section of the clock-in lane to the second section of the clock-in lane, respectively. The clock-in lane is subdivided into a plurality of intervals, wherein the clocking device is configured so as to control a transfer of a piece of washware from a first interval to a neighboring second interval, accordingly.

In order to implement such a clocking device, it is contemplated that, for subdividing the clock-in lane into the intervals, the clocking device comprises blocking elements that respectively define the end of each interval of the clock-in lane and can be retracted and extracted into the clock-in lane for blocking and releasing the transfer of the piece of washware from the first interval of the clock-in lane to the neighboring second interval of the clock-in lane.

The clocking device is configured in particular so as to drive the respective blocking elements associated with the intervals of the clock-in lane in such a way that the blocking elements are simultaneously retracted or extracted into the clock-in lane, so that the transfer of the piece of washware from the first interval to the neighboring second interval of the clock-in lane is only released when there is no longer a piece of washware in the second interval or when a piece of washware is moving from the second interval into a third interval neighboring the second interval or in the direction of the main conveyor belt of the conveyor warewasher.

The time-based control of the blocking elements is preferably carried out in synchronization with the transport speed of the main conveyor belt of the conveyor warewasher. In this way, in particular, sensor technology that is configured so as to detect corresponding compartments for receiving the washware pieces to be clocked in can be omitted.

With respect to the dirt collection region of the loading system, it is advantageously provided that the dirt collection region is connected via a dirt drop shaft to a dirt collection region provided near an inlet or loading region of a conveyor warewasher associated with the loading system, wherein the dirt drop shaft is preferably configured such that the dirt collected in the dirt collection region of the loading system passes or can pass by way of gravity via the dirt drop shaft into the dirt collection region located at the inlet or loading region of the conveyor warewasher.

In particular, the dirt drop shaft can be configured as a dirt drop channel or as a dirt drop slide.

It is furthermore advantageous that the dirt collection region is connected via the dirt waste shaft to an existing sieve drawer (including a dirt collection region) of the recessed inlet of the conveyor warewasher. As a result, a larger volume is provided for receiving the dirt falling away during the 180° rotation. The sieve drawer can either be manually emptied as needed or it can be connected to an automatic wet waste disposal system. This allows for uninterrupted operation for as long as possible without having to empty the dirt collection region.

The invention further relates to an assembly for at least semi-automated cleaning of washware pieces, wherein the assembly comprises a feeding system, in particular in the form of a feed conveyor belt, for feeding the washware pieces to be cleaned. Moreover, the assembly comprises a conveyor warewasher having at least one conveyor apparatus (main conveyor belt), in particular in the form of a conveyor belt, for feeding the pieces of washware to be cleaned to at least one treatment zone of the conveyor warewasher.

In order to transfer the washware pieces to be cleaned from the feeding system to the conveying apparatus of the conveyor warewasher, a loading system of the aforementioned type according to the invention is used in the assembly according to the invention.

In implementations of the assembly according to the invention, it is provided that at least in the region between the feeding system and the loading system, the pieces of washware to be cleaned are fed by the feeding system substantially perpendicular to the extension direction of the conveyor belt of the loading system, and wherein the extension direction of the conveyor belt of the loading system at least substantially corresponds to the extension direction of the conveyor apparatus of the conveyor warewasher at least in a loading region of the conveyor warewasher.

### BRIEF DESCRIPTION OF THE DRAWINGS

The invention is described in further detail below with reference to the accompanying drawings, in which the following are shown:

FIG. 1 schematically, and in an isometric view, an exemplary embodiment of the assembly according to the invention for at least semi-automated cleaning of washware pieces, wherein, in FIG. 1 the feeding system, the loading system, and the loading region of a conveyor warewasher of the assembly are shown;

FIG. 2 schematically, and in a side view, the exemplary embodiment of the assembly according to the invention according to FIG. 1;

FIG. 3 schematically, and in a top plan view, the exemplary embodiment of the assembly according to the invention according to FIG. 1;

FIG. 4 schematically, and in an isometric view, an embodiment of the loading system employed in the assembly according to FIG. 1, namely with corresponding covers of the clock-in lanes of the loading system;

FIG. 5 schematically, and in a top plan view, the loading system according to FIG. 4;

FIG. 6 schematically, and in an isometric view, the loading system according to FIG. 4, but without the covers of the clock-in lanes;

FIG. 7 schematically, and in a top plan view, the loading system according to FIG. 6;

FIG. 8A schematically, and in a partially cut side view, the loading system according to FIG. 4;

FIG. 8B schematically, and in a partially cut side view, the loading system according to FIG. 8A, wherein, however, the turning apparatus of the loading system, proceeding from its first position as shown in FIG. 8A, is situated in an intermediate position between the first position and the second position that is rotated by 180° and shown in FIG. 8C; and

FIG. 8C schematically, and in a partially cut side view, the loading system according to FIG. 8B, wherein, however, the turning apparatus is now situated in the second position that is rotated by 180° compared to the first position according to FIG. 3A.

### DETAILED DESCRIPTION

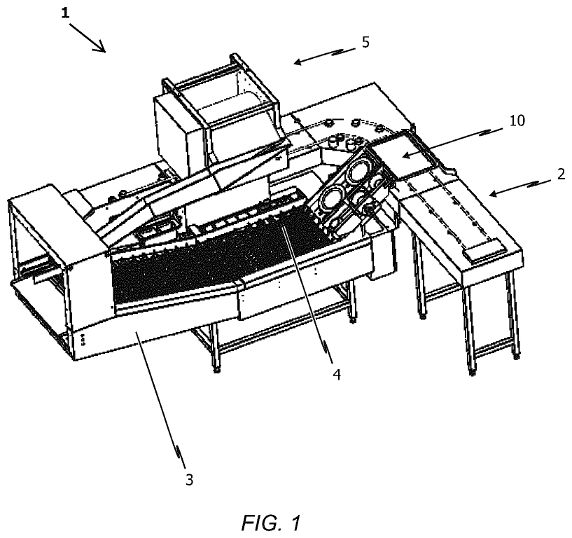

The assembly 1 for at least semi-automated cleaning of washware pieces 100 as shown schematically and in an isometric view in FIG. 1 comprises a feeding system 2 in the form of a feed conveyor belt, via which the washware pieces 100 to be cleaned are fed to a loading system 10.

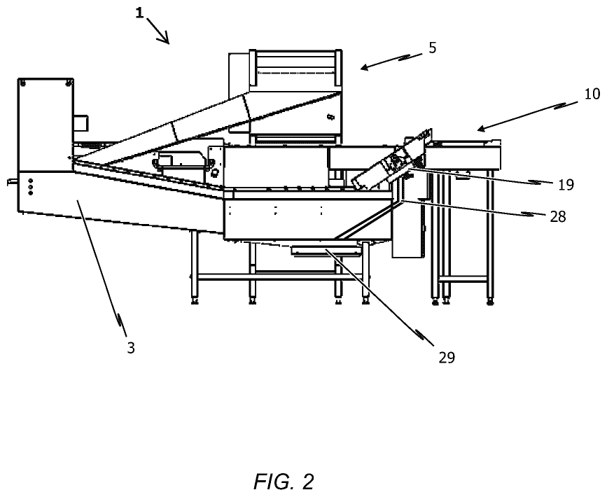

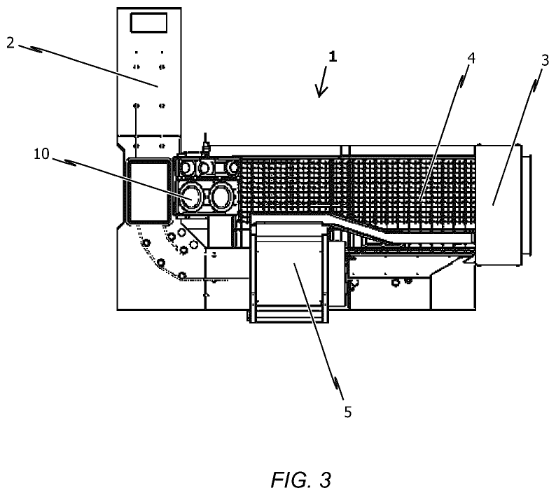

FIG. 2, schematically and in a side view, shows the exemplary embodiment of the assembly according to FIG. 1, and FIG. 3, schematically and in a top view, shows the exemplary embodiment of the assembly according to FIG. 1.

In particular, it is contemplated that, via the feeding system 2 or via the feed conveyor belt, place settings consisting of a tray and corresponding washware pieces 100 received on the tray and to be cleaned are fed to a first, in particular upper region 12 of the loading system 10.

The place settings with the washware pieces 100 to be cleaned can be placed directly by the diner or by the washing personnel on the feed conveyor belt. The feed conveyor belt or feeding system 2 then conveys the place settings to the intake or loading region of the conveyor warewasher 3. There, for example, the cutlery and crockery parts are manually removed from the trays, and the manually removed crockery parts are then manually sorted into corresponding clock-in lanes 14, 15 of the loading system 10.

In the embodiment of the assembly 1 according to the invention as shown in FIG. 1, the empty trays are then fed via the feeding system 2 to an automatic tray clock-in 5. There, while being fed, the trays are placed into an upright position and then placed into a corresponding tray track of the warewasher 3. This process is preferably fully automatic.

As shown in FIG. 1 through FIG. 3, the feeding system 2 or feed conveyor belt is run past the front side of the inlet region of the conveyor belt dishwasher 3. At the height of the inlet region of the conveyor warewasher 3, the semi-automated loading system 10 is located, in which, for example, the plates and bowls from the fed place settings are placed into dedicated clock-in lanes 14, 15 of the loading system 10. The operator stands in the front at a loading position with a view towards the conveyor warewasher 3.

Depending on the required washware capacity, it is also contemplated that a conveyor warewasher 3 having a wider main conveyor belt 4 than the one shown in FIG. 1 to FIG. 3 can be used, such that one or more further clock-in lanes can be added on the loading system 10, which can be loaded from the first loading position by the same operator or, if there is increased capacity demand, can be loaded separately by a second operator standing directly adjacent at a further loading station.

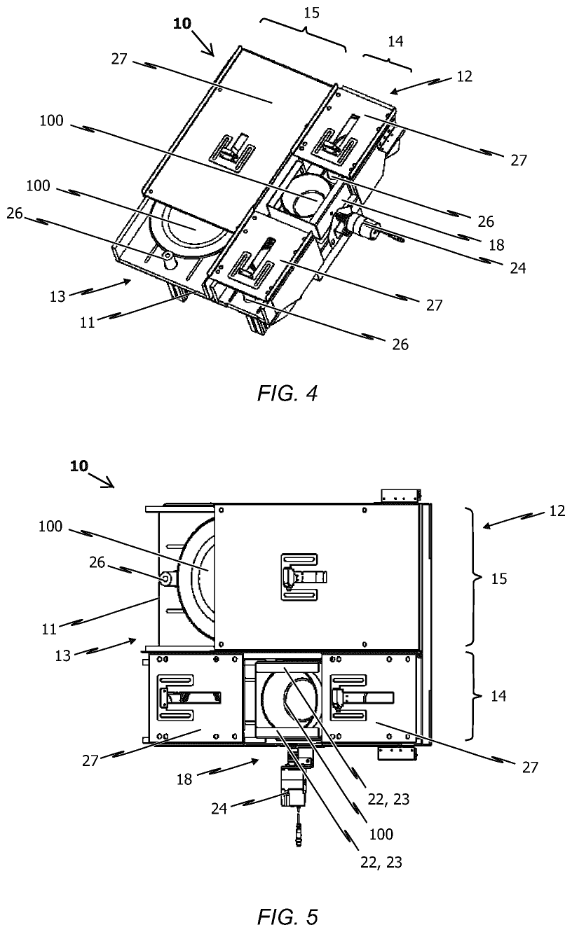

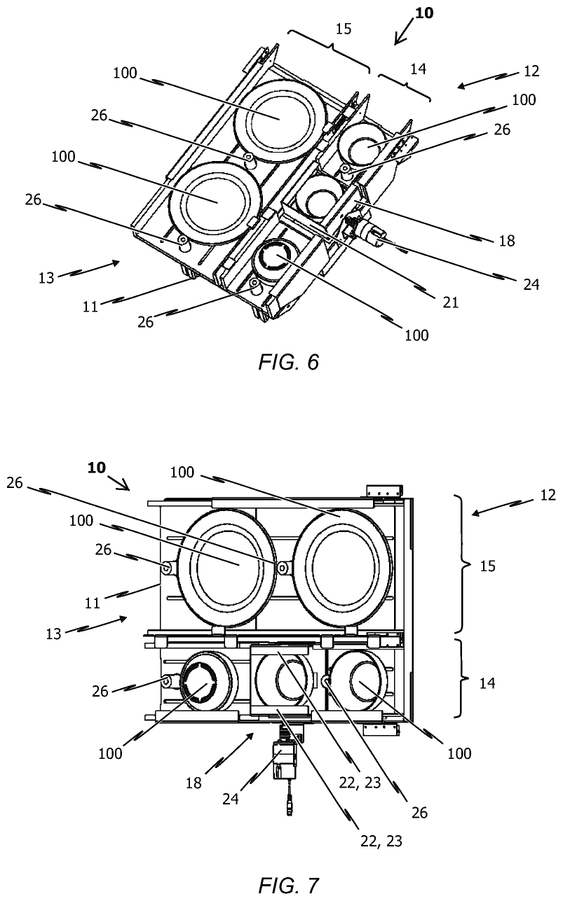

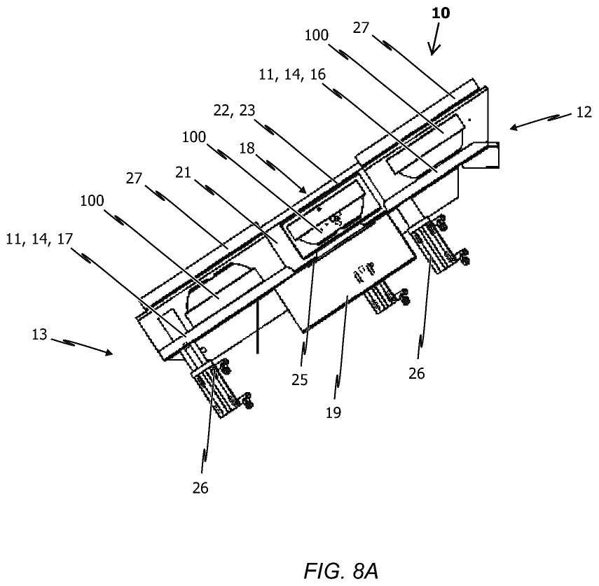

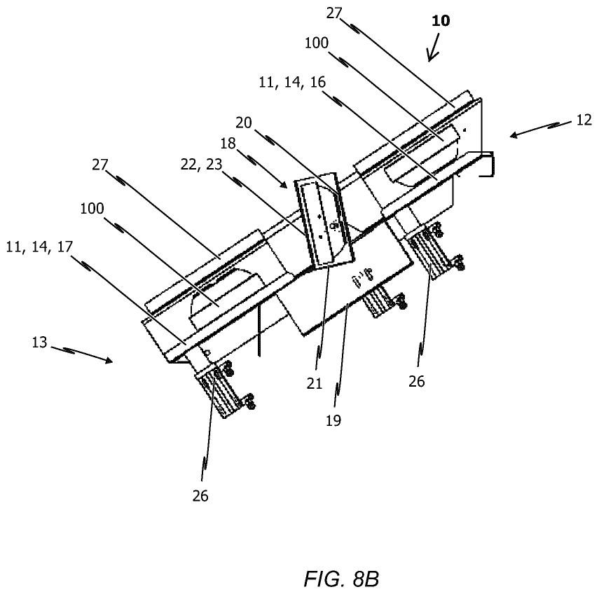

As shown in FIG. 2 through FIG. 7, the loading system 10 used in the assembly 1 as shown in FIG. 1 to FIG. 3, comprises a conveyor belt 11, configured in particular as a slide, which is or can be inclined in particular in relation to the horizontals in such a way that a piece of washware 100 placed in an in particular upper first region 12 of the conveyor belt 11 is movable, preferably exclusively by gravity, to or in the direction of an in particular lower second region 13 of the conveyor belt 11 lying opposite the first region 12.

In the loading system 10 as shown in FIG. 2 to FIG. 7, the conveyor belt 11 is subdivided into two clock-in lanes 14, 15 running parallel to one another, each extending in the longitudinal extension direction of the conveyor belt 11. In the embodiment of the loading system 10 according to the invention as shown in FIG. 2 to FIG. 7, it is provided that the first clock-in lane 14 is assigned to a first type of washware and the second clock-in lane 15 is assigned to a second type of washware. The first type of washware is in particular bowls, while the second type of washware is plates or saucers.

The first type of washware, i.e., the bowls in this case, are preferably to be rotated by 180° for efficient cleaning in the conveyor warewasher 3, so that they can be clocked into the main conveyer belt of the conveyor warewasher 3 in an ideal position.

To this end, in the embodiment of the loading system 10 according to the invention as shown in FIG. 2 to FIG. 7, it is provided that the first clock-in lane 14 is subdivided into an upper first section 16 and a lower second section 17, wherein, in a region between the first and second sections 16, 17 of the first clock-in lane 14, a turning apparatus connecting the first section 16 of the clock-in lane 14 to the second section 17 of the clock-in lane 14 is arranged.

In the embodiment of the loading system 10 according to the invention as shown in FIG. 2 to FIG. 7, it is further provided that washware of a particular size and/or dimensions or washware of a particular type are assigned to each clock-in lane 14, 15 of the conveyor belt 11.

Preferably, at least one cover 27 is associated with the clock-in lanes 14, 15, being configured so as to cover the associated clock-in lane 14, 15 at least partially or regionally from above, so that the clock-in lane 14, 15 forms with the cover 27 a shaft-like channel for receiving corresponding pieces of washware 100, wherein the cover 27 is preferably configured so as to be removable from the associated clock-in lane 14, 15.

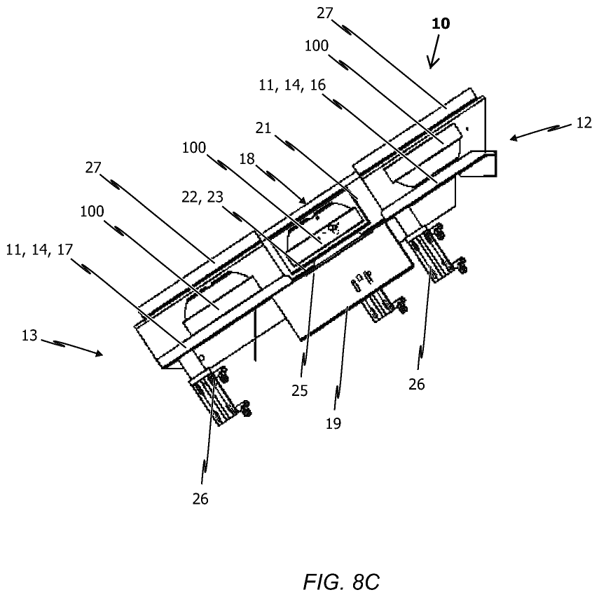

As can be seen in particular in the illustration in FIG. 8A to FIG. 8C, the turning apparatus is configured so as to turn a piece of washware 100 picked up from the first clock-in lane 14 and moved in the region between the first and second sections 16, 17 of the first clock-in lane 14 by 180° and subsequently transfer the piece of washware 100 which has been turned by 180° to the second section 17 of the clock-in lane 14.

In particular, it is provided that, below the region between the first and second sections 16, 17 of the clock-in lane 14, a dirt collection region 19 is provided, in which dirt can be received, having fallen from the piece of washware 100 by way of gravity upon turning of the piece of washware 100.

In the loading system 10 shown in the drawings, the turning apparatus is configured as a turning compartment 18, in particular in the form of a drawer which is open on one side and at least substantially box-shaped.

As illustrated in FIG. 8A to FIG. 8C, the turning compartment 18 can be transferred between a first position in which the piece of washware 100 picked up from the first clock-in lane 14 and moved in the region between the first and second sections 16, 17 of the first clock-in lane 14 is received at least partially or regionally by the turning compartment 18 (cf. FIG. 8A) and a second position in which the turning compartment 18 with the piece of washware 100 received at least partially or regionally by the turning compartment 18 has been turned by 180° in relation to the first position of the turning compartment (cf. FIG. 8C).

The illustration in FIG. 8A shows that the turning compartment 18 comprises a floor region 20 in the first position of the turning compartment 18 and a front wall region 21 facing the second section of the clock-in lane 14 in the first position of the turning compartment 18. The washware piece 100 preferably abuts against the front wall region 21 of the turning compartment 18 when, in the first position of the turning compartment 18 (cf. FIG. 8A), the washware piece 100 is or has been received at least partially or regionally.

Furthermore, the illustration in FIG. 8A shows that, in the first position of the turning compartment 18, the surface of the floor region 20, the surface of the first section 16 of the clock-in lane 14, and the surface of the second section 17 of the clock-in lane 14 lie in a common plane.

Considering FIGS. 8A, FIG. 8B, and FIG. 8C together, it can be seen that the turning compartment 18 of the loading system 10 is pivotally mounted about an at least substantially horizontally extending axis between the first and second positions relative to the first and second sections 16, 17 of the first clock-in lane 14.

The view in FIG. 8C shows that the turning compartment 18 is pivotally mounted about the at least substantially horizontally extending axis in such a way that the front wall region 21 of the turning compartment 18 faces the first section 16 of the clock-in lane 14 in the second position of the turning compartment 18.

It can further be seen that the turning compartment 18 comprises a support 22, which is configured so as to prevent the piece of washware 100 that has been received at least partially or regionally by the turning compartment 18 from falling out of the turning compartment 18 upon transfer of the turning compartment 18 from the first position (cf. FIG. 8A) into the second position (cf. FIG. 8C).

Although it is generally contemplated that the support 22 is configured as a supporting body that can be inserted into the turning compartment 18, in the embodiment of the loading system 10 according to the invention as shown in the drawings, it is provided that the support 22 is realized by a guide 23.

Specifically, the turning compartment 18 comprises a guide 23 extending in the longitudinal extension direction of the conveyor belt 11 and running parallel to the floor region 20 of the turning compartment 18, in particular in the form of a guide bar or guide rail.

In this context, however, it is also contemplated that the at least one guide 23 is configured as an undercut.

As illustrated in FIG. 8C, in the second position of the turning compartment 18, the surface of the guide 23, the surface of the first section 16 of the first clock-in lane 14, and the surface of the second section 17 of the first clock-in lane 14 lie in a common plane.

From the view in FIG. 8B, by contrast, it can be seen that the at least one guide 23 is likewise configured so as to prevent the piece of washware 100 that has been received at least partially or regionally by the turning compartment 18 from falling out of the turning compartment 18 upon transfer of the turning compartment 18 from the first position (cf. FIG. 8A) into the second position (cf. FIG. 8C).

As indicated in FIG. 2 to FIG. 7, the turning apparatus comprises an actuator 24, which is configured so as to transfer the turning compartment 18 as needed from the first position to the second position (and vice versa). The actuator 24 is in particular an electrical actuator 24, wherein, however, actuators that operate electromagnetically, pneumatically, or hydraulically are also contemplated.

Although not explicitly shown in FIG. 2 to FIG. 7, the turning apparatus further comprises a sensor system, in particular in the form of a presence detector or presence counter, which is configured so as to detect a state when a piece of washware 100 is received at least partially or regionally by the turning compartment 18. The actuator 24 of the loading system 10 or the actuator 24 of the turning apparatus comprises a control device, which is configured so as to drive the actuator 24 in such a manner that the actuator 24 transfers the turning compartment 18 into the second position when it is detected that a piece of washware 100 has been received at least partially or regionally by the turning compartment 18.

In particular, it is contemplated in this context that the turning compartment 18 is pivotally mounted about an axis extending at least substantially horizontally and preferably perpendicular to the longitudinal extension direction of the conveyor belt 11 in such a way that the turning compartment 18 moves independently or automatically from the first position towards the second position when, proceeding from the first position of the turning compartment 18, a piece of washware 100 is or has been received at least partially or regionally by the turning compartment 18.

In this respect, the aforementioned sensor system can be configured so as to detect that the turning compartment 18 is moving from the first position into the second position, so that this movement can be used as a sensor-detectable trigger in order to activate the actuator.

It can further be seen in the illustration in FIG. 2 to FIG. 7 that the dirt falling from the piece of washware 100 by way of gravity upon turning of the piece of washware 100 can be supplied to the dirt collection region 19 via an opening 25 defined by an edge region of the dirt collection region 19. In the design variant of the loading system 10 according to the invention as shown in FIG. 2, it is provided that the edge region of the dirt collection region 19 defining the opening 25 of the dirt collection region 19 lies in a plane that is spaced apart from and preferably parallel to the plane in which the surface of the floor region 20 of the turning compartment 18 lies in the first position of the turning compartment 18 (cf. FIG. 8A).

As shown in FIG. 2, the dirt collection region 19 is connected via a dirt drop shaft 28 to a dirt collection region 29 provided near an inlet or loading region of a conveyor warewasher 3 associated with the loading system 10, wherein the dirt drop shaft 28 is preferably configured such that the dirt collected in the dirt collection region 19 of the loading system 10 passes or can pass by way of gravity via the dirt drop shaft 28 into the dirt collection region 29 located at the inlet or loading region of the conveyor warewasher 3.

The loading system 10 according to the exemplary embodiment as shown in the drawings further comprises a device for clocking the movement of the pieces of washware 100 received in the clock-in lanes 14, 15 from the first region 12 of the conveyor belt 11 to the second region 13 of the conveyor belt 11. The clock-in lanes 14, 15 are subdivided into a plurality of intervals, wherein the clocking device is configured so as to control a transfer of a piece of washware 100 from a first interval to a neighboring second interval.

For subdividing the clock-in lane 14, 15 into the intervals, the clocking device comprises blocking elements 26 that respectively define the end of each interval and can be retracted and extracted into the clock-in lane 14, 15 in order to block and release the transfer of the piece of washware 100 from the first interval to the second interval.

The clocking device is configured so as to drive the respective blocking elements 26 associated with the intervals of the clock-in lane 14, 15 in such a way that the blocking elements 26 are simultaneously retracted and extracted into the clock-in lane 14, 15, so that the transfer of the piece of washware 100 from the first interval to the second interval is only released when there is no longer a piece of washware 100 in the second interval or when a piece of washware 100 is already moving from the second interval into a third interval neighboring the second interval.

In summary, the object of the invention is to further reduce the manual handling steps, so that plates and bowls can be semi-automatically sorted into the main conveyor belt in order to, in this way:
reduce manual operator steps and thus reduce effort for the operator by optimizing the movement flow for the loading of plates and bowls for the operator through:
   Elimination of 90° rotation of the upper body between the tray conveyor belt and the conveyor belt of the dishwasher; the plates and bowls only need to be lifted from the tray and placed in front-facing loading openings of the loading system 10, i.e., much shorter and more ergonomic movement;
   No 180° rotation of the bowls between removal of the bowls from the tray and loading of the bowls into the conveyor belt; the rotation of the bowls occurs within the loading system 10;
   No sorting of the washware into dedicated conveyor belt compartments; the clocking of the washware into the conveyor belt is performed by the loading system 10;
improve the cleaning result of the conveyor warewasher 3, because all of the washware is uniformly oriented on the conveyor belt and passes through the machine within dedicated tracks for each type;
simplify the unloading process, because each type of washware is transported through the warewasher on a defined lane and thus arrives at the unloading region of the warewasher in a pre-sorted manner.

The invention thus relates in particular to the following aspects:

Aspect 1: The belt conveyor dishwasher is equipped with a loading unit for clocking in at least one piece of washware 100 into the conveyor belt of the belt conveyor dishwasher, wherein, through the combination of a slide, driven conveying device, or the like, and a turning unit, it is ensured that the washware piece is automatically clocked into the conveyor belt with the washware-specific orientation.

Aspect 2: The machine according to Aspect 1, characterized in that, due to the slope of the clock-in lanes, the washware preferably slides by way of gravity into the subsequent clock-in positions and then ultimately into the conveyor belt of the warewasher. Alternatively, the transport into the downstream clock-in position can also be carried out via an additional drive, e.g., a conveyor belt, etc.

Aspect 3: The machine according to Aspect 1, characterized in that the loading unit additionally has a turning unit depending on the type of washware, in order to be able to rotate the washware, such as bowls that must be cleaned with the opening 25 facing downwards for a good cleaning result, so that the washware can be placed upwards into the loading unit with the opening 25 facing downwards and then clocked into the conveyor belt dishwasher by the loading unit with the opening 25 facing downwards. An alternative embodiment provides that the turning unit is always part of a clock-in lane 14 and the turning unit then only actually turns the washware as needed, i.e., depending on the type of washware inserted, and simply remains deactivated when not needed.

Aspect 4: The machine according to Aspect 1 and Aspect 3, characterized in that the turning unit is moved, for example, by an electrical, pneumatic, magnetic, etc. drive, or alternatively the rotational movement is initiated by gravity, e.g., using an off-centered rotational axis, so that the rotational movement is initiated directly by way of gravity when the washware slides into the turning unit.

Aspect 5: The machine according to Aspect 1, characterized in that the individual clock-in lanes have one or more washware positions, so that a placement of washware into the upper setting position is only possible when the previously set washware has been transferred out of the setting position into the underlying position.

Aspect 6: The machine according to Aspect 1, characterized in that the loading unit is designed so as to be either manually loaded by a machine operator or alternatively automatically, e.g., by an upstream robot, gripping arm, or the like, which automatically transfers the washware from the tray into the respective setting positions.

Aspect 7: The machine according to Aspect 1 and Aspect 2, characterized in that, below the turning apparatus, there is a dirt collection apparatus that traps the food residue falling out during rotation by gravity and selectively diverts them into a sieve drawer.

Aspect 8: The machine according to Aspect 1, characterized in that the loading apparatus has a cover, which covers the one or more clock-in lanes, wherein the cover is designed so that a horizontal surface results above the placement openings, which can be used as a storage space/buffer region for washware that generally cannot be placed into one of the openings due to either shape or size, or which can be theoretically placed but cannot be placed directly at the moment of removal from the tray, because the setting position at that moment is occupied by the previously placed washware piece 100.

Aspect 9: The machine according to aspect 1, characterized in that the loading openings are equipped with an optical signal (e.g., red and green lighting) to visualize the current loading state of the placement openings for the operators (e.g., red=setting position occupied, green=setting position free)

Aspect 10: The machine according to aspect 1, characterized in that the loading unit can optionally be equipped with further clock-in lanes for further washware types, e.g., glasses and/or cutlery, in order to also clock this washware into the conveyor belt of the dishwasher according to the same principle.

The invention is not limited to the embodiments shown in the drawings, but rather results when all of the features disclosed herein are considered together.

### LIST OF REFERENCE NUMERALS

1 Assembly
2 Feeding system
3 Conveyor warewasher
4 Conveyor apparatus/main conveyor belt of the conveyor warewasher
5 Tray stacking
10 Loading system
11 Conveyor belt
12 First region of the conveyor belt
13 Second region of the conveyor belt
14 First clock-in lane
15 Second clock-in lane
16 First section of the first clock-in lane
17 Second section of the first clock-in lane
18 Turning apparatus/turning compartment
19 Dirt collection region
20 Floor region of the turning compartment
21 Front-facing wall region of the turning compartment
22 Support
23 Guide
24 Actuator
25 Opening of the dirt collection region
26 Blocking element
27 Cover
28 Dirt drop shaft
29 Dirt collection region
100 Washware piece

1. A loading system for loading at least one conveyor warewasher with washware, wherein the loading system comprises:
a conveyor belt, which is or can be inclined in relation to the horizontals in such a way that a piece of washware placed in an upper first region of the conveyor belt is movable, by gravity, to or in the direction of a lower second region of the conveyor belt lying opposite the first region,
wherein the conveyor belt comprises at least one clock-in lane extending in the longitudinal extension direction of the conveyor belt, wherein the at least one clock-in lane is subdivided into an upper first section and a lower second section, wherein, in a region between the first and second sections of the clock-in lane, a turning apparatus connecting the first section of the clock-in lane with the second section of the clock-in lane is arranged, which is configured so as to turn as needed a piece of washware picked up from the clock-in lane and moved in the region between the first and second sections of the clock-in lane by 180° and subsequently transfer the piece of washware which has been turned by 180° to the second section of the clock-in lane, wherein, below the region between the first and second sections of the clock-in lane, a dirt collection region is provided, in which dirt can be received, having fallen from the piece of washware by way of gravity upon turning of the piece of washware.

2. The loading system according to claim 1,
wherein the turning apparatus comprises a turning compartment, in the form of a drawer which is open on one side and at least substantially box-shaped, which can be transferred between a first position in which the piece of washware picked up from the clock-in lane and moved in the region between the first and second sections of the clock-in lane is received at least partially or regionally by the turning compartment and a second position in which the turning compartment with the piece of washware received at least partially or regionally by the turning compartment has been turned by 180° in relation to the first position of the turning compartment.

3. The loading system according to claim 2, wherein the turning compartment is pivotally supported about an at least substantially horizontally extending axis between the first and second positions in relation to the first and second sections of the clock-in lane.

4. The loading system according to claim 3, wherein the turning compartment comprises a lower floor region—in the first position of the turning compartment—and a front region—in the first position of the turning compartment—facing the second section of the clock-in lane, in a wall region, wherein the piece of washware abuts the front region of the turning compartment when, in the first position of the turning compartment, the piece of washware is or has been received at least partially or regionally.

5. The loading system according to claim 4,
wherein the turning compartment is pivotally mounted about the at least substantially horizontally extending axis in such a way that the front region of the turning compartment faces the first section of the clock-in lane in the second position of the turning compartment.

6. The loading system according to claim 4, wherein, in the first position of the turning compartment, the surface of the floor region, the surface of the first section of the clock-in lane, and the surface of the second section of the clock-in lane lie in a common plane.

7. The loading system according to claim 2,
wherein the turning compartment comprises at least one support, which is configured so as to prevent the piece of washware that has been received at least partially or regionally by the turning compartment from falling out of the turning compartment upon transfer of the turning compartment from the first position to the second position.

8. The loading system according to claim 7,
wherein the at least one support comprises a supporting body, which can be inserted as needed, laterally, into the turning compartment.

9. The loading system according to claim 2,
wherein the turning compartment comprises at least one guide configured as an undercut extending in the longitudinal extension direction of the conveyor belt and running parallel to the floor region of the turning compartment, in the form of a guide bar or guide rail, wherein, in the second position of the turning compartment, the surface of the guide, the surface of the first section of the clock-in lane, and the surface of the second section of the clock-in lane lie in a common plane.

10. The loading system (10) according to claim 9,
wherein the at least one guide is configured so as to prevent the piece of washware that has been received at least partially or regionally by the turning compartment from falling out of the turning compartment upon transfer of the turning compartment from the first position to the second position.

11. The loading system according to claim 2,
wherein the turning apparatus comprises an actuator which operates electrically, electromagnetically, pneumatically, or hydraulically and is configured so as to transfer the turning compartment as needed from the first position to the second position, and vice versa.

12. The loading system according to claim 11,
wherein the turning apparatus comprises a sensor system, in the form of a presence detector or presence counter, which is configured so as to detect a state when a piece of washware is received at least partially or regionally by the turning compartment, and wherein a control device is associated with the actuator, being configured so as to drive the actuator in such a manner that the actuator transfers the turning compartment into the second position when it is detected that a piece of washware has been received at least partially or regionally by the turning compartment.

13. The loading system according to claim 12, wherein the turning compartment is pivotally mounted about an axis extending at least substantially horizontally and perpendicular to the longitudinal extension direction of the conveyor belt in such a way that the turning compartment moves independently or automatically from the first position towards the second position when, in the first position of the turning compartment, a piece of washware is or has been received at least partially or regionally by the turning compartment.

14. The loading system according to claim 13, wherein the sensor system is configured so as to detect that the turning compartment is moving from the first position towards the second position when, in the first position of the turning compartment, a piece of washware is or has been received at least partially or regionally by the turning compartment.

15. The loading system according to claim 2,
wherein the dirt falling from the piece of washware by gravity upon turning of the piece of washware is or can be supplied to the dirt collection region via an opening defined by an edge region of the dirt collection region, wherein the edge region of the dirt collection region defining the opening of the dirt collection region lies in a plane that is spaced apart from and parallel to the plane in which the surface of the floor region of the turning compartment lies in the first position of the turning compartment.

16. The loading system according to claim 1,
wherein the turning apparatus can be activated as needed, wherein, in a non-activated state of the turning apparatus, the piece of washware that has been picked up by the clock-in lane and moved into the region between the first and second sections of the clock-in lane is transferred to the second section of the clock-in lane without a 180° turning of the piece of washware.

17. The loading system according to claim 1,
wherein the conveyor belt is configured at least partially or regionally as a roller belt having a plurality of rollers extending perpendicular to the longitudinal extension direction of the conveyor belt and being in particular rotatably supported.

18. The loading system according to claim 1,
wherein the conveyor belt comprises a handling device by means of which the piece of washware placed into the first region of the conveyor belt is movable to or in the direction of the second region of the conveyor belt.

19. The loading system according to claim 1,
wherein the conveyor belt is subdivided into a plurality of clock-in lanes running parallel to one another, wherein not every clock-in lane is equipped with a turning apparatus.

20. The loading system according to claim 1,
wherein at least one cover is associated with the at least one clock-in lane, being configured so as to cover the associated clock-in lane at least partially or regionally from above, so that the clock-in lane forms with the cover a shaft-like channel for receiving corresponding pieces of washware, wherein the cover is configured so as to be removable from the associated clock-in lane.

21. The loading system according to claim 1,
wherein the loading system comprises a device for clocking the movement of the pieces of washware received in a clock-in lane from the first region of the conveyor belt to the second region of the conveyor belt, wherein the clock-in lane is subdivided into a plurality of intervals, and wherein the clocking device is configured so as to control a transfer of a piece of washware from a first interval in relation to a neighboring second piece of washware.

22. The loading system according to claim 21,
wherein, for subdividing the clock-in lane into the intervals, the clocking device comprises blocking elements that respectively define the end of each interval and can be retracted and extracted into the clock-in lane for blocking and releasing the transfer of the piece of washware from the first interval to the neighboring second interval.

23. The loading system according to claim 21, wherein the clocking device is configured so as to drive the respective blocking elements associated with the intervals of the clock-in lane in such a way that the blocking elements are simultaneously retracted or extracted into the clock-in lane, so that the transfer of the piece of washware from the first interval to the second interval is only released when there is no longer a piece of washware in the second interval or moving from the second interval into a third interval neighboring the second interval.

24. The loading system according to claim 1,
wherein the dirt collection region is connected via a dirt drop shaft to a dirt collection region provided near an inlet or loading region of a conveyor warewasher associated with the loading system, wherein the dirt drop shaft is configured such that the dirt collected in the dirt collection region of the loading system passes or can pass by way of gravity via the dirt drop shaft into the dirt collection region located at the inlet or loading region of the conveyor warewasher.

25. An assembly for at least semi-automated cleaning of pieces of washware, wherein the assembly comprises the following:
a feeding system, in the form of a feeding conveyor belt, for feeding the pieces of washware to be cleaned;
a conveyor warewasher having at least one conveyor apparatus, in the form of a conveyor belt, for feeding the pieces of washware to be cleaned to at least one treatment zone of the conveyor warewasher; and
a loading system according to claim 1.

26. The assembly according to claim 25,
wherein, at least in the region between the feeding system and the loading system, the pieces of washware to be cleaned are fed by the feeding system substantially perpendicular to the extension direction of the conveyor belt of the loading system, and wherein the extension direction of the conveyor belt of the loading system at least substantially corresponds to the extension direction of the conveyor apparatus of the conveyor warewasher at least in a loading region of the conveyor warewasher.
